(19) United States
(12) Patent Application Publication
(10) Pub. No.: US 2015/0103614 A1
(43) Pub. Date: Apr. 16, 2015

(54) APPARATUS AND METHOD FOR A CONCRETE PLANT

(71) Applicant: Astec, Inc., Chattanooga, TN (US)

(72) Inventors: J. Donald Brock, Chattanooga, TN (US); Earl Edwards, Trenton, GA (US); Malcolm L. Swanson, Chickamauga, GA (US); Michael A. Bremmer, Albuquerque, NM (US); James P. Johnson, Soddy Daisy, TN (US)

(73) Assignee: Astec, Inc., Chattanooga, TN (US)

(21) Appl. No.: 14/573,679

(22) Filed: Dec. 17, 2014

Related U.S. Application Data
(63) Continuation-in-part of application No. 12/657,816, filed on Jan. 28, 2010, now abandoned.
(60) Provisional application No. 61/206,122, filed on Jan. 28, 2009.

(51) Int. Cl. B28C 7/04; B01F 13/00; B28C 7/00; B28C 9/04; B01F 15/02; B28C 7/06

(52) U.S. Cl. CPC B28C 7/0422; B01F 15/0229; B28C 7/06; B28C 7/0053; B28C 9/04; B01F 13/004; B01F 2215/0047; B01F 2015/0204
USPC 366/3

(57) ABSTRACT

A concrete plant comprising an aggregate feed bin adapted to hold and release aggregate materials, a feed conveyor adapted to receive the aggregate materials from the aggregate feed bin, a collecting belt conveyor adapted to receive the aggregate materials from the feed conveyor, a silo assembly adapted to hold and release components of concrete, a screw conveyor adapted to receive the components of concrete from the silo assembly and convey the components of concrete to the collecting belt conveyor, and a mixer adapted to receive the aggregate materials and components of concrete from the collecting belt conveyor and mix the aggregate materials and components of concrete with water. The amount of aggregate materials received by the collecting belt conveyor from the conveyor and the amount of concrete components received by the collecting belt conveyor from the conveyor are precisely and accurately controlled.

### CROSS-REFERENCES TO RELATED APPLICATIONS/PATENTS

This application is a Continuation-in-Part of U.S. application for patent Ser. No. 12/657,816 filed on Jan. 28, 2010, which application relates back to and claims the benefit of priority from U.S. Provisional Application for Patent No. 61/206,122 filed on Jan. 28, 2009, both entitled “Apparatus and Method for a Concrete Plant.”

### FIELD OF THE INVENTION

The present invention relates generally to concrete plants adapted to produce concrete, and particularly to concrete plants that are adapted to control the mixture of concrete components.

### BACKGROUND AND DESCRIPTION OF THE PRIOR ART

It is known to produce concrete using a concrete plant. However, conventional concrete plants suffer from one or more disadvantages. For example, conventional concrete plants do not precisely and accurately control the mixture of concrete components. More particularly, conventional concrete plants do not precisely and accurately control the aggregate components of concrete, e.g. the stone and sand. Indeed, conventional concrete plants do not screen the stone components of concrete to a desired size prior to introducing the stone components into the concrete mixture. As a result, the sizes and quantities of the stone components that are used in the concrete mixture are not known with a high degree of certainty at a conventional concrete plant. In addition, at a conventional concrete plant, similar sized stones tend to segregate from different sized stones, further diminishing the uniformity of the stone components throughout the concrete. Conventional concrete plants are also required to use an excessive amount of expensive cement because the stone components of concrete are not precisely and accurately controlled. Further, while conventional concrete plants are adapted to produce batches of concrete, they are not adapted to continuously produce concrete. As a result, conventional concrete plants have a reduced production capacity. Still further, mixing the components of concrete at a conventional concrete plant is difficult because the discrete masses of the different components are mixed entirely within the mixer. Based on all of these disadvantages, conventional concrete plants produce concrete that experiences excessive failure rates and shortened lifespans. Finally, while conventional concrete plants include portable types, they require excessive amounts of time to set up before being operational because they lack significant self-erection capability.

It would be desirable, therefore, if an apparatus and method for a concrete plant could be provided that would precisely and accurately control the mixture of concrete components, including the stone and sand components of concrete. It would also be desirable if such a concrete plant could be provided that would screen the stone components of concrete to a desired size before introducing the stone components into the concrete mixture. It would be further desirable if such a concrete plant could be provided that would allow the sizes and quantities of the stone components that are used in the concrete mixture to be known with a high degree of certainty. It would be still further desirable if such a concrete plant could be provided that would prevent similar sized stones from segregating away from different sized stones and would increase the uniformity of the stone components throughout the concrete. In addition, it would be desirable if such a concrete plant could be provided that would use less cement as a component of concrete. It would also be desirable if such a concrete plant could be provided that would continuously produce concrete in order to increase production capacity. It would be further desirable if such a concrete plant could be provided that would at least partially mix the components of concrete before they are introduced into the mixer. It would be still further desirable if such a concrete plant could be provided that would produce concrete that experiences reduced failure rates and longer lifespans. Finally, it would be desirable if such a concrete plant could be provided that would be portable and capable of being set up and operational in a reduced amount of time.

### Advantages of the Preferred Embodiments of the Invention

Accordingly, it is an advantage of the preferred embodiments of the invention described herein to provide a method and an apparatus for a concrete plant that precisely and accurately controls the mixture of concrete components, including the stone and sand components of concrete. It is also an advantage of the preferred embodiments of the invention to screen the stone components of concrete to a desired size before introducing the stone components into the concrete mixture. It is another advantage of the preferred embodiments of the invention to allow the sizes and quantities of the stone components that are used in the concrete mixture to be known with a high degree of certainty. It is still another advantage of the preferred embodiments of the invention to prevent similar sized stones from segregating away from different sized stones and to increase the uniformity of the stone components throughout the concrete. It is yet another advantage of the preferred embodiments of the invention to use less cement as a component of concrete. It is a still further advantage of the preferred embodiments of the invention to continuously produce concrete in order to increase production capacity. It is a still further advantage of the preferred embodiments of the invention to at least partially mix the components of concrete before they are introduced into the mixer. It is also an advantage of the preferred embodiments of the invention to produce concrete that experiences reduced failure rates and longer lifespans. Finally, it is an advantage of the preferred embodiments of the invention to provide a portable concrete plant that may be set up and operational in a reduced amount of time.

Additional advantages of the preferred embodiments of the invention will become apparent from an examination of the drawings and the ensuing description.

### EXPLANATION OF TECHNICAL TERMS

As used herein, the term “concrete” means a hard, strong substance that is composed of cement and aggregate such as stone, gravel and sand which is mixed with water and allowed to dry and harden. The term “concrete” also contemplates the addition of additives or admixtures, including but not limited to, air entrainment, water reducers such as low range water reducers, mid-range water reducers and high range water reducers (superplasticizers), microsilica (condensed silica fume), corrosion inhibitors such as silica fume and chloride-free admixtures, set accelerators such as chloride-free admixtures, set retarders, strength enhancers such as superplasticizer admixtures, shrinkage reducing admixtures, flowability admixtures such as Type F and Type G superplasticizers, finishing enhancers such as mid-range water reducing admixtures, cold weather admixtures such as Type C accelerators and a Type F combination of accelerators and water reducers, hot weather admixtures such as a Type D combination of water reducing and set retarding admixtures, fly ash such as Class C and Class F fly ash, silica fume and the like to the mixture described in the preceding sentence.

### SUMMARY OF THE INVENTION

The apparatus of the invention comprises a concrete plant adapted to manufacture concrete. The concrete plant comprises one or more aggregate feed bins adapted to hold and release aggregate materials, one or more feed conveyors adapted to receive the aggregate materials from the one or more aggregate feed bins, a collecting belt conveyor adapted to receive the aggregate materials from the one or more feed conveyors, one or more silo assemblies adapted to hold and release components of concrete, one or more screw conveyors adapted to receive the components of concrete from the one or more silo assemblies and convey the components of concrete to the collecting belt conveyor, and a mixer adapted to receive the aggregate materials and components of concrete from the collecting belt conveyor and mix the aggregate materials and components of concrete with water. In the preferred embodiments of the apparatus of the invention, the amount of aggregate materials received by the collecting belt conveyor from the one or more feed conveyors and the amount of concrete components received by the collecting belt conveyor from the one or more screw conveyors are precisely and accurately controlled.

The invention also comprises a method for manufacturing concrete. The method comprises providing a concrete plant adapted to manufacture concrete. The concrete plant comprises one or more aggregate feed bins adapted to hold and release aggregate materials, one or more feed conveyors adapted to receive the aggregate materials from the one or more aggregate feed bins, a collecting belt conveyor adapted to receive the aggregate materials from the one or more feed conveyors, one or more silo assemblies adapted to hold and release components of concrete, one or more screw conveyors being adapted to receive the components of concrete from the one or more silo assemblies and convey the components of concrete to the collecting belt conveyor, and a mixer adapted to receive the aggregate materials and components of concrete from the collecting belt conveyor and mix the aggregate materials and components of concrete with water. In the preferred embodiments of the apparatus of the invention, the amount of aggregate materials received by the collecting belt conveyor from the one or more feed conveyors and the amount of concrete components received by the collecting belt conveyor from the one or more screw conveyors are precisely and accurately controlled. The method also comprises mixing the aggregate materials and the components of concrete with water in the mixer to produce concrete.

### BRIEF DESCRIPTION OF THE DRAWINGS

The presently preferred embodiments of the invention are illustrated in the accompanying drawings, in which like reference numerals represent like parts throughout, and in which:

FIG. 1 is a front view of the preferred embodiment of the concrete plant in accordance with the present invention.

FIG. 1A is a front view of the preferred mixer conveyor illustrated in FIG. 1 shown in the travelling position.

FIG. 1B is a front view of the preferred mixer, water tank and control center illustrated in FIG. 1.

FIG. 1C is a front view of the preferred mixer, water tank and control center illustrated in FIGS. 1 and 1B shown in the travelling position.

FIG. 2 is a top view of the preferred concrete plant illustrated in FIG. 1.

FIG. 3 is a front view of the preferred feed bin, short feeder conveyor and collecting conveyor assembly illustrated in FIGS. 1 and 2.

FIG. 4 is a left side view of the preferred concrete plant illustrated in FIGS. 1-3.

FIG. 5 is a left side view of the preferred silo assembly illustrated in FIGS. 1-4 in a retracted position.

FIG. 6 is a front view of a first alternative embodiment of the concrete plant in accordance with the present invention.

FIG. 7 is a top view of the first alternative embodiment of the concrete plant illustrated in FIG. 6.

FIG. 8 is a top view of a second alternative embodiment of the concrete plant in accordance with the present invention.

FIG. 9 is a front view of the trailing aggregate section of the second alternative embodiment of the concrete plant illustrated in FIG. 8.

FIG. 10 is a front view of the leading aggregate section of the second alternative embodiment of the concrete plant illustrated in FIGS. 8-9.

FIG. 11 is a front view of the mixer conveyor of the second alternative embodiment of the concrete plant illustrated in FIGS. 8-10.

FIG. 12 is a front view of the mixing equipment section of the second alternative embodiment of the concrete plant illustrated in FIGS. 8-11.

FIGS. 13A and 13B are a flow chart illustrating the preferred method for continuously controlling component amounts in a concrete mixture in accordance with the present invention.

FIG. 14 is a flow chart illustrating the prior art batch method for producing concrete.

### DESCRIPTION OF THE PREFERRED EMBODIMENTS OF THE INVENTION

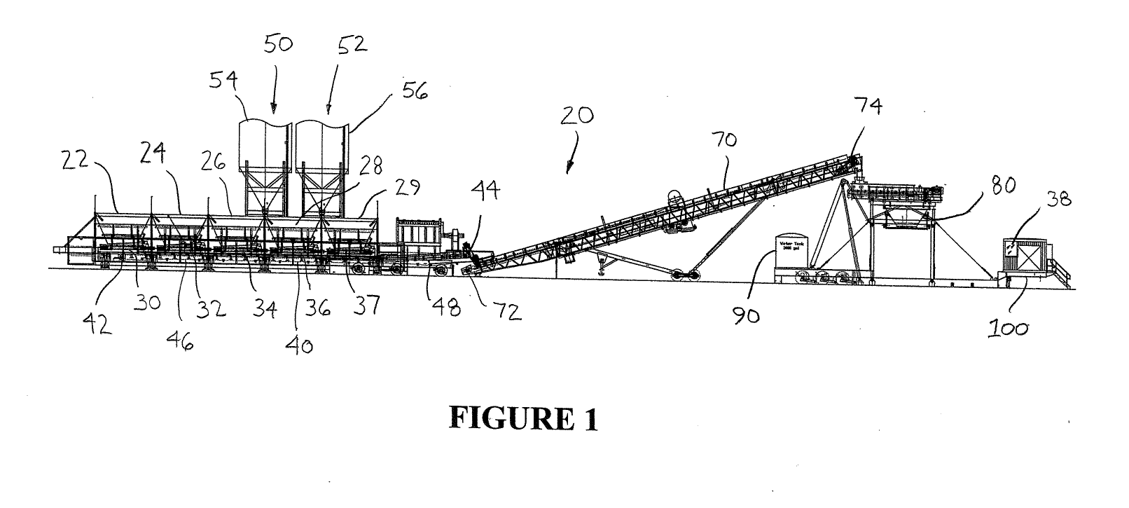

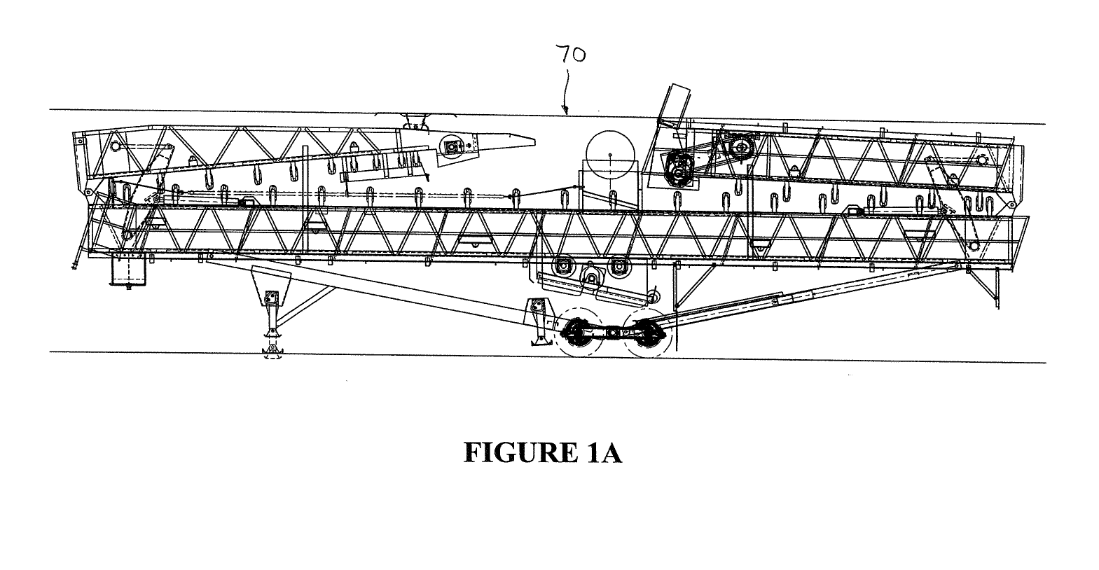

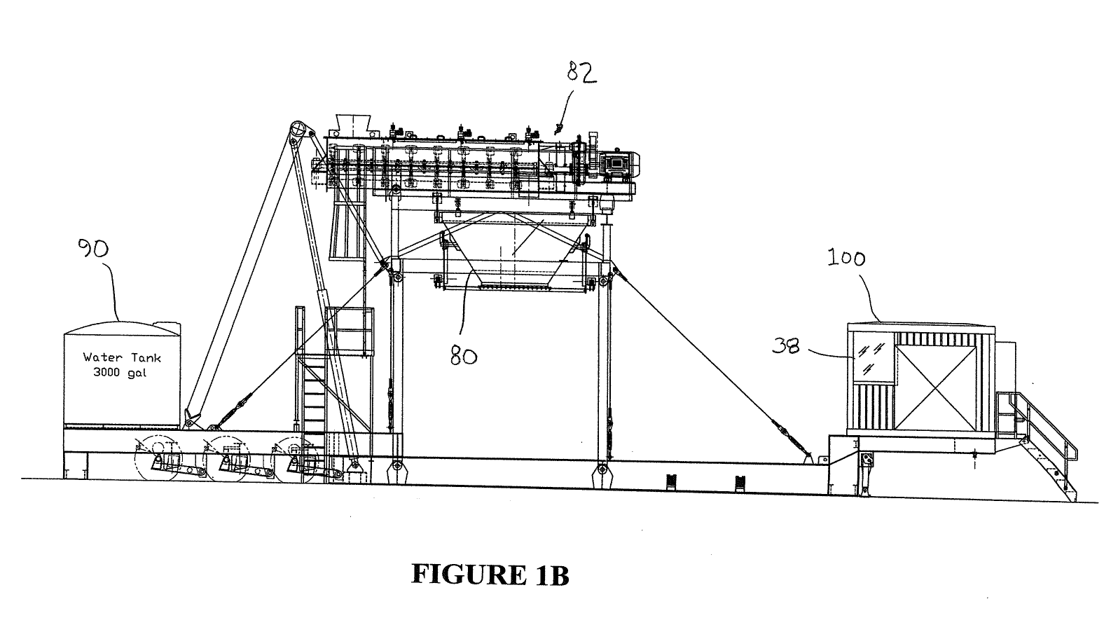

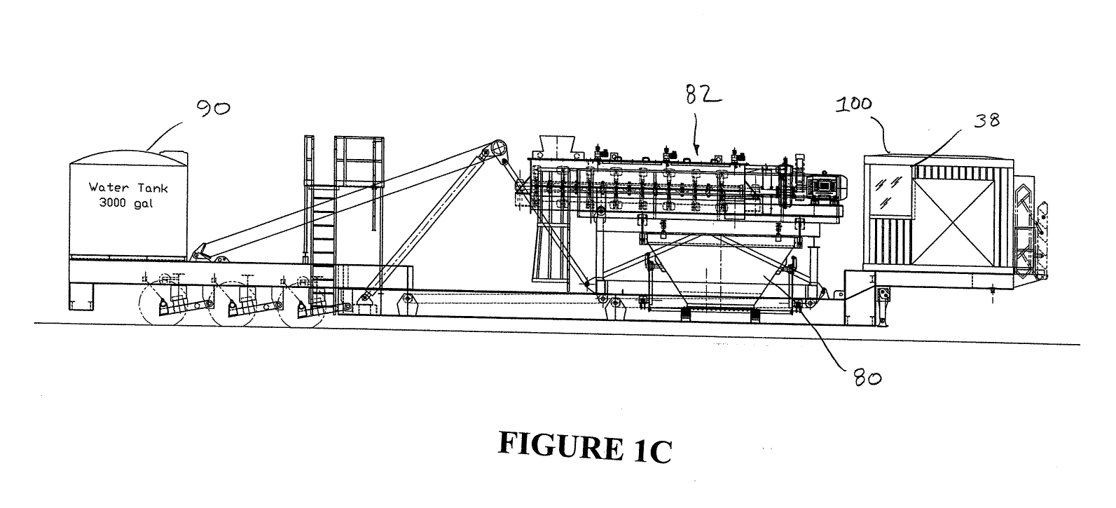

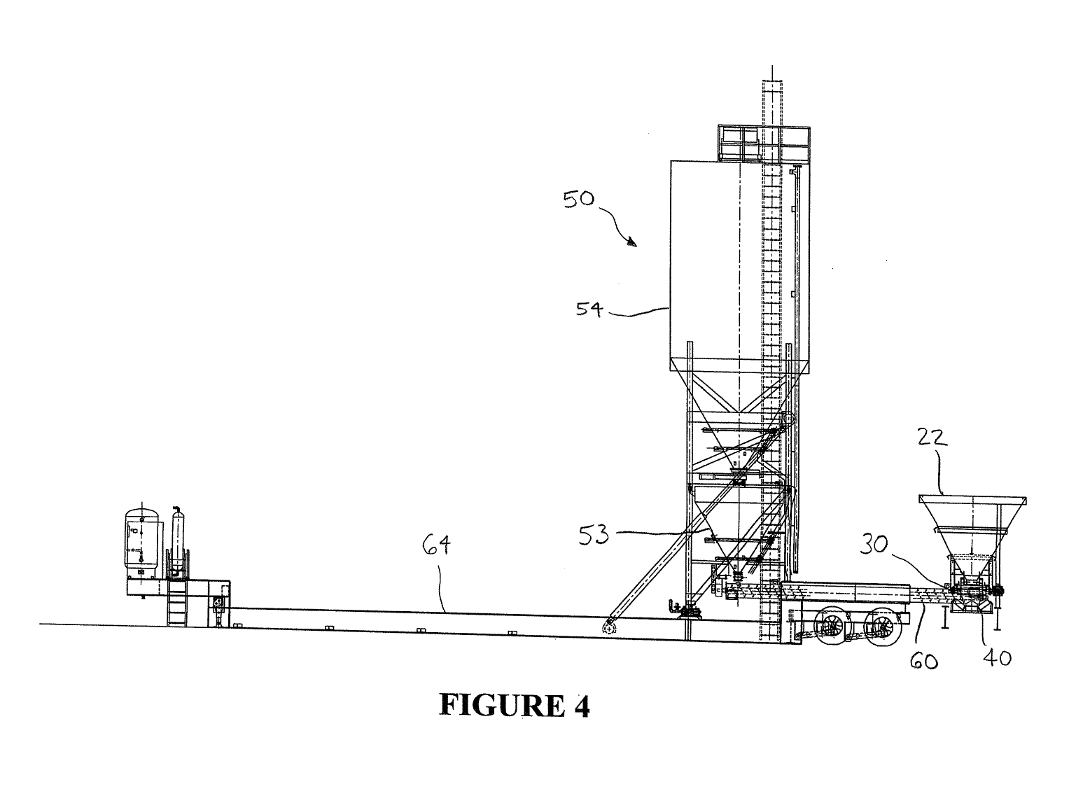

Referring now to the drawings, the preferred embodiments of the apparatus and method for a concrete plant are illustrated by FIGS. 1-14. As shown in FIGS. 1-14, the preferred embodiments of the apparatus and method for a concrete plant are adapted to precisely and accurately control the mixture and production of concrete. More particularly, the preferred embodiments of the invention are adapted to precisely and accurately control the stone and sand components of concrete and allow for the continuous production of concrete. The preferred embodiments of the invention are also adapted to produce concrete using less cement and at least partially mix the components of concrete before the components are introduced into the mixer.

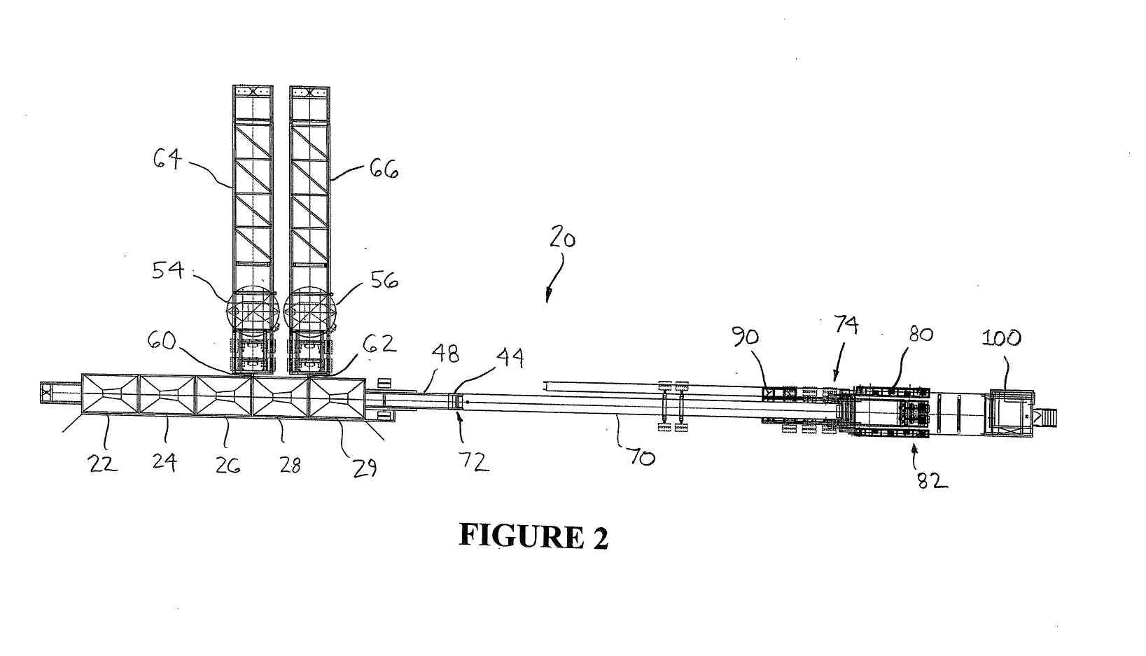

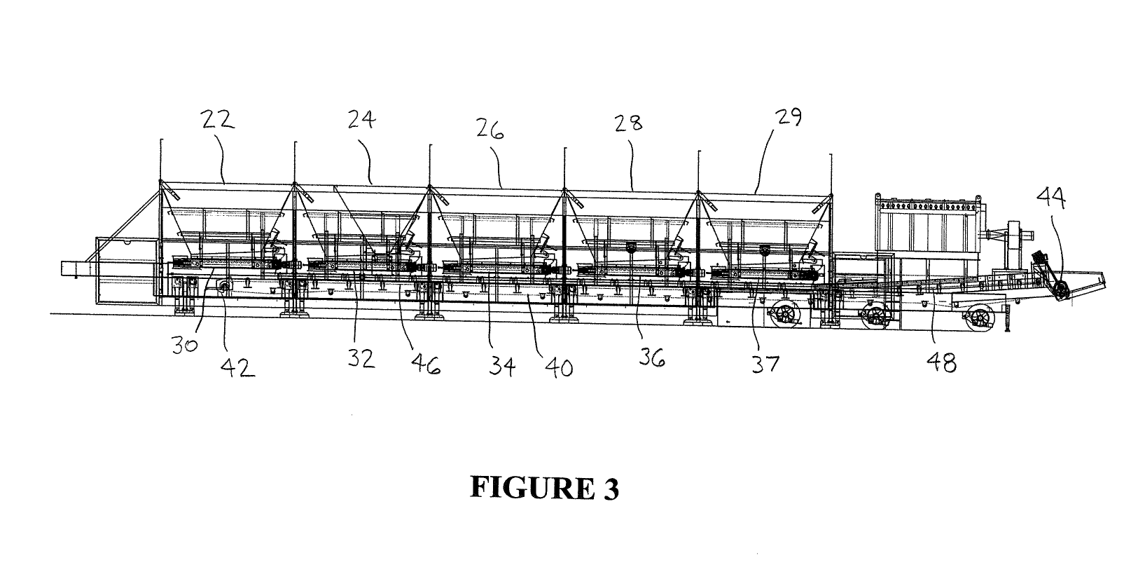

Referring now to FIG. 1, a front view of the preferred embodiment of the concrete plant in accordance with the present invention is illustrated. As shown in FIG. 1, the preferred concrete plant is designated generally by reference numeral 20. The preferred concrete plant 20 includes a plurality of aggregate feed bins 22, 24, 26, 28 and 29 which are adapted to hold and release a variety of aggregate materials such as stone, gravel, sand and the like. See also FIGS. 2 and 3. The preferred aggregate feed bin 22 is adapted to hold and release fine aggregate. The preferred fine aggregate has a maximum size of approximately one quarter inch (0.25″). The preferred aggregate feed bin 24 is adapted to hold and release intermediate aggregate. The preferred intermediate aggregate has a minimum size of approximately one quarter inch (0.25″) and a maximum size of approximately one-half inch (0.5″). The preferred aggregate feed bin 26 is also adapted to hold and release intermediate aggregate. Preferably, aggregate feed bin 28 is adapted to hold and release coarse aggregate. The preferred coarse aggregate has a minimum size of approximately one-half inch (0.5″) and a maximum size of approximately one inch (1.0″). While preferred concrete plant 20 includes four aggregate feed bins, it is contemplated within the scope of the invention that more or fewer aggregate feed bins may be used. It is further contemplated that the aggregate feed bins may be of any suitable configuration and arrangement.

Still referring to FIG. 1, each of the preferred aggregate feed bins 22, 24, 26, 28 and 29 is adapted to feed the aggregate held therein to a short feeder conveyor 30, 32, 34, 36 and 37, respectively. See also FIG. 3. The preferred short feeder conveyors 30, 32, 34 and 36 are adapted to operate at variable speeds depending upon the desired rate of aggregate flow. More particularly, the preferred aggregate feed bins 22, 24, 26, 28 and 29 and the preferred short feeder conveyors 30, 32, 34, 36 and 37 comprise a plurality of variable speed volumetric belt feeders in which the rate at which aggregates are fed onto the collecting conveyor and the speed of the short feeder conveyors can be precisely and accurately controlled. Preferably, the preferred short feeder conveyors 30, 32, 34, 36 and 37 are driven by a variable speed AC motor and the motor speed is controlled by a variable speed drive that varies the frequency of the power to the motor. In the preferred embodiments of the concrete plant, the volumetric belt feeders are operatively connected to and controlled by a microprocessor or CPU 38. It is contemplated within the scope of the invention, however, that the short feeder conveyors may be driven by any suitable device, mechanism, assembly or combination thereof and the rate of the conveyors may be controlled by any suitable device, mechanism, assembly or combination thereof. It is also contemplated within the scope of the invention that each of the short feeder conveyors may be operated at the same rate or at one or more different rates.

Referring still to FIG. 1, the preferred short feeder conveyors 30, 32, 34, 36 and 37 are adapted to convey aggregate to collecting belt conveyor 40 which is preferably disposed below the bins and the short feeder conveyors. See also FIGS. 2 and 3. The preferred collecting belt conveyor 40 has an upstream end 42 and a downstream end 44 and is fully shrouded. The preferred collecting belt conveyor 40 is adapted to move concrete components in a direction from the upstream end 42 toward the downstream end 44. Preferably, the collecting belt conveyor 40 is operated at a constant rate, however, it is contemplated within the scope of the invention that the collecting belt conveyor may be operated at variable rates. As shown in FIGS. 1 and 3, the preferred collecting belt conveyor 40 has a horizontal portion 46 disposed below short feeder conveyors 30, 32, 34, 36 and 37 and an inclined portion 48 disposed at downstream end 44.

While FIGS. 1 and 3 illustrate the preferred configuration and arrangement of the collecting belt conveyor, it is contemplated within the scope of the invention that the collecting belt conveyor may be of any suitable configuration and arrangement. It is also contemplated within the scope of the invention that the collecting belt conveyor may comprise more than one conveyor belt.

Still referring to FIG. 1, the preferred concrete plant 20 also includes silo assemblies 50 and 52. See also FIGS. 2, 4 and 5. The preferred silo assemblies 50 and 52 are adapted to hold and release components of concrete. Preferably, silo assembly 50 includes silo 54 which holds and releases cement. The preferred silo assembly 52 includes silo 56 which holds and releases flyash. The preferred silo assemblies 50 and 52 are adapted to precisely and accurately control the weight of the concrete components released therefrom. More particularly, each of the preferred silo assemblies 50 and 52 includes “weigh pot” 53 that is charged through a butterfly valve located above the pot and below the cone of the silo. Each of the preferred “weigh pots” is filled with the contents of the silo it is disposed below, and then the contents are conveyed to collecting belt conveyor 40 via rotary vane feeders. Each “weigh pot” 53 is mounted on a load cell so the diminishing weight of the pot as material is removed is known by the microprocessor or CPU 38 to which the load cell is operatively connected. While FIG. 1, illustrates the preferred number, configuration and arrangement of the silo assemblies, it is contemplated that any suitable number, configuration and arrangement of silo assemblies may be provided. It is also contemplated within the scope of the invention that one or more silos may include two or more compartments, each of which is adapted to hold and release a different concrete component. In addition, it is contemplated within the scope of the invention that any suitable device, mechanism, assembly or combination thereof may be used to control the release and measurement of the silo contents.

Referring now to FIGS. 2, 4 and 5, the preferred concrete plant 20 also includes screw conveyors 60 and 62. Each preferred screw conveyor 60 and 62 is adapted to convey the concrete component held by silos 54 and 56, respectively, to collecting belt conveyor 40. While the concrete components released by the silos are preferably conveyed to the collecting belt conveyor by screw conveyors, it is contemplated within the scope of the invention that any suitable device, mechanism, assembly or combination thereof may be used to convey the concrete components released by the silos. The preferred silo assemblies 50 and 52 also include trailer frames 64 and 66, respectively. The preferred silo assemblies 50 and 52 also include air-bag suspensions which provide a smooth ride during transport and allow trailer frames 64 and 66, respectively, to be lowered toward the ground so as to provide a foundation for the assemblies.

Referring to FIGS. 1-4, the preferred concrete plant 20 is adapted to feed the components of concrete onto collecting conveyor 40 in layers. More particularly, preferred short feeder conveyor 30 is adapted to feed an initial layer of aggregate such as fine aggregate directly onto collecting belt conveyor 40. Next, preferred short feeder conveyor 32 is adapted to feed another layer of aggregate such as intermediate aggregate onto the initial layer of aggregate. Then, preferred screw conveyor 60 is adapted to convey a layer of cement onto the layers of aggregate. Next, preferred short feeder conveyor 34 is adapted to feed another layer of aggregate such as intermediate aggregate onto the layer of cement. Then, preferred screw conveyor 62 is adapted to convey a layer of flyash onto the layer of aggregate. Finally, preferred short feeder conveyor 36 is adapted to convey another layer of aggregate such as coarse aggregate onto the layer of flyash. Consequently, the components of concrete are at least partially mixed before they reach the mixer. In addition, the preferred sequence of components minimizes the likelihood that concrete components will either stick to the collecting conveyor or be blown off the conveyor before reaching the mixer.

While the foregoing is the preferred sequence of layers of concrete components, it is also contemplated within the scope of the invention that the short feed conveyors may convey (and the aggregate feed bins may hold) different aggregate materials than described above. For example, if the desired concrete does not include enough fine aggregate to keep the cement from contacting and sticking to the collecting conveyor and does include a relatively large proportion of intermediate or coarse aggregate, it may be preferable to use intermediate or coarse aggregate in bin 22 and fine aggregate in bin 28.

Referring to FIGS. 1, 1A, and 2, the preferred concrete plant 20 includes mixer conveyor 70. The preferred mixer conveyor 70 has upstream end 72 and downstream end 74. The upstream end of mixer conveyor 70 is preferably disposed below the downstream end 44 of collecting belt conveyor 40. The downstream end 74 of mixer conveyor 70 is preferably disposed above mixer 80 (see also FIGS. 1B and 1C). The preferred mixer 80 is a twin shaft pugmill, however, it is contemplated within the scope of the invention that any suitable type of mixer may be used. Preferably, mixer 80 includes an automated wash-down system 82 adapted to thoroughly wash down the interior of the mixing chamber and allow all concrete components to be flushed therefrom. The preferred wash-down system includes pre-positioned nozzles inside the mixing chamber of mixer 80. The preferred wash-down system may be activated manually or by a microprocessor or CPU 38. The preferred mixer 80 also includes access doors that may be opened to provide access to the mixing chamber and allow high-pressure wash wands to enter the mixing chamber. While FIGS. 1 and 2 illustrate the preferred embodiment of concrete plant 20, it is contemplated within the scope of the invention that the collecting belt conveyor may convey concrete components directly to a mixer or a screen. It is also contemplated that more than one mixer may be provided.

Still referring to FIGS. 1 and 2, the preferred concrete plant also comprises water tank 90 and control center 100. The preferred water tank 90 is adapted to hold and release water to be mixed with the concrete components. Preferably, concrete plant 20 includes a water distribution system that is adapted to deliver a continuous curtain of water sprayed around falling components to produce uniformly wet concrete components. The preferred control center 100 is adapted to house the microprocessor or CPU 38 that controls the operation of the volumetric belt feeders and monitors the load cells.

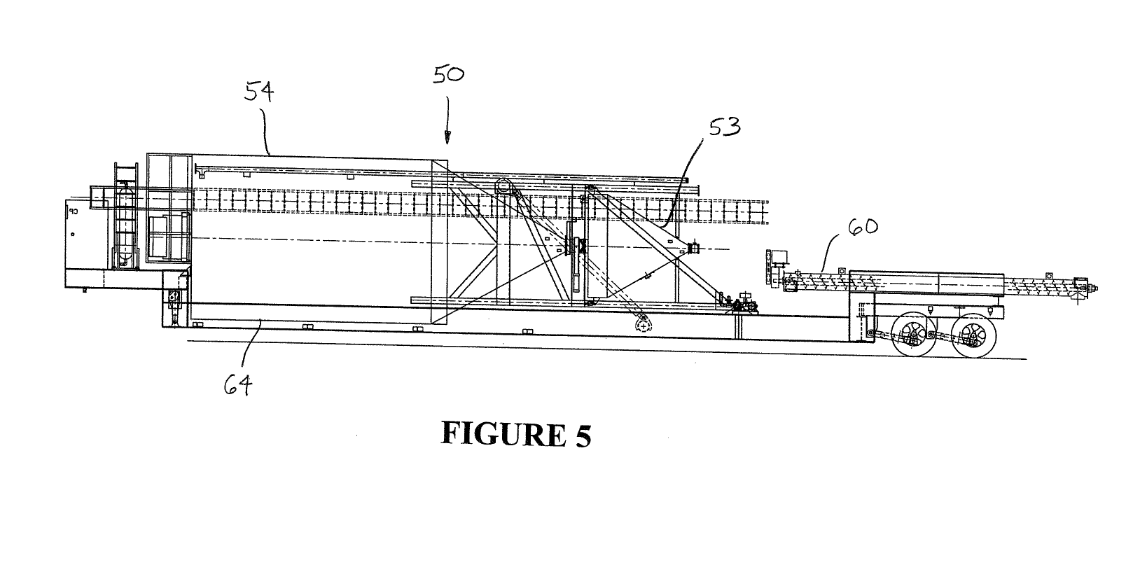

Referring now to FIG. 5, a left side view of the preferred silo assembly 50 is illustrated in a retracted or traveling position. As shown in FIG. 5, the preferred silo 54 of silo assembly 50 is adapted to be moved from a substantially vertical position to a substantially horizontal position in order to facilitate the transport of the silo assembly.

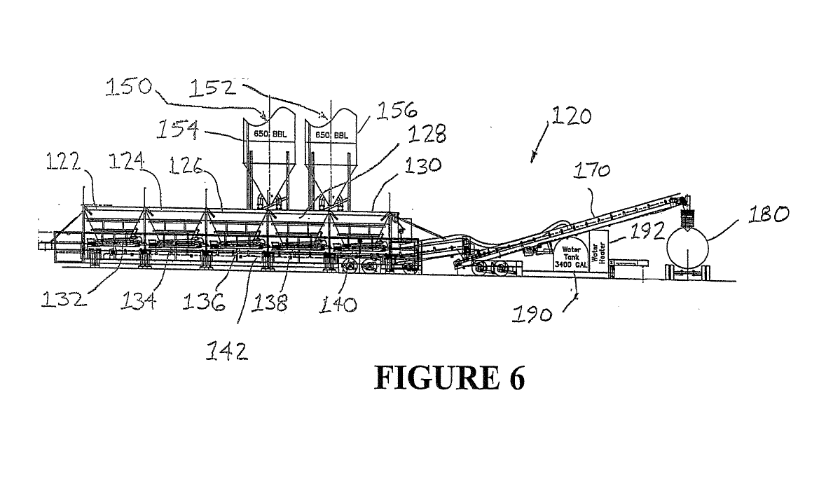

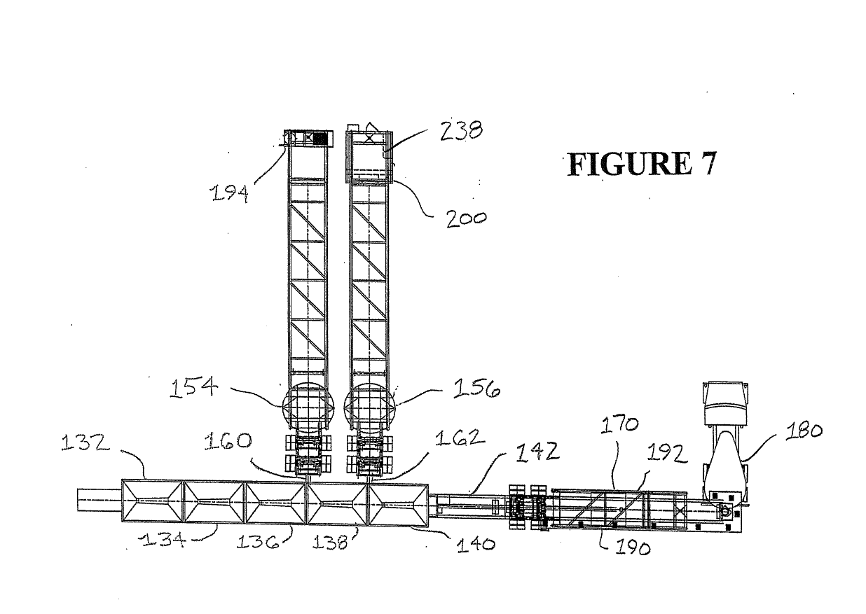

Referring now to FIG. 6, a front view of an alternative embodiment of the concrete plant in accordance with the present invention is illustrated. As shown in FIG. 6, the alternative embodiment of the concrete plant is designated generally by reference numeral 120. Preferred concrete plant 120 includes aggregate feed bins 122, 124, 126, 128 and 130 which are adapted to hold and release a variety of aggregate materials such as stone, gravel, sand and the like. See also FIG. 7. Each of the preferred aggregate feed bins 122, 124, 126, 128 and 130 is adapted to feed the aggregate held therein to a short feeder conveyor 132, 134, 136, 138 and 140, respectively. The preferred short feeder conveyors 132, 134, 136, 138 and 140 are adapted to operate at variable speeds depending upon the desired rate of aggregate flow. The preferred short feeder conveyors 132, 134, 136, 138 and 140 are adapted to convey aggregate to a collecting belt conveyor 142 which is preferably disposed below the bins.

Still referring to FIG. 6, the preferred concrete plant 120 also includes silo assemblies 150 and 152. See also FIG. 7. The preferred silo assemblies 150 and 152 are adapted to hold and release components of concrete. Referring now to FIG. 7, the preferred concrete plant 20 also includes screw conveyors 160 and 162. Each preferred screw conveyor 160 and 162 is adapted to convey the concrete component held by silo assemblies 154 and 156, respectively, to collecting belt conveyor 142. The preferred concrete plant 120 also includes mixer conveyor 170. The preferred mixer conveyor 170 is adapted to convey the concrete components conveyed by collecting belt conveyor 142 to mixer truck 180. The preferred concrete plant 120 also comprises water tank 190, water heater 192, air conditioner 194 and control center 200. The preferred water tank 190 is adapted to hold and release water to the concrete components after they have been mixed in mixer truck 180. The preferred water heater 192 is adapted to control the temperature of the water held in water tank 190. The preferred air conditioner 194 is adapted to control the temperature in control center 200. The preferred control center 200 is adapted to house the microprocessor or CPU 238 that controls the operation of the volumetric belt feeders and monitors the load cells.

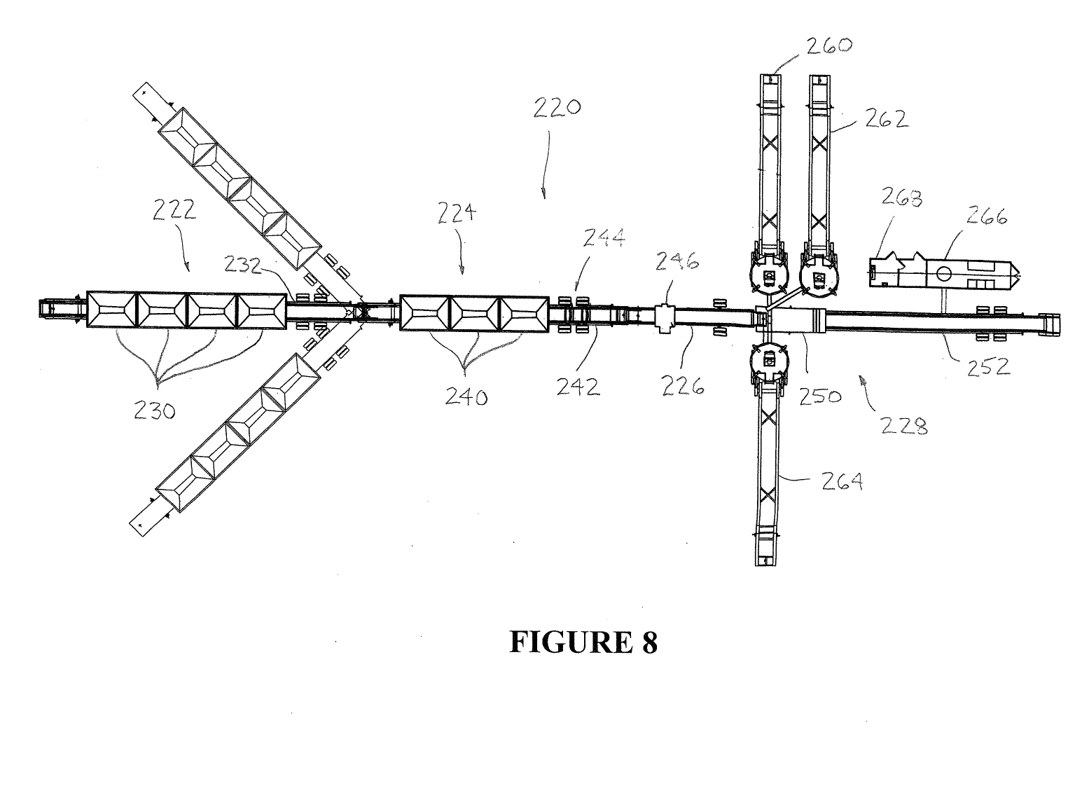

Referring now to FIG. 8, a top view of a second alternative embodiment of the concrete plant in accordance with the present invention is illustrated. As shown in FIG. 8, the second alternative embodiment of the concrete plant is designated generally by reference numeral 220. Preferred concrete plant 220 comprises trailing aggregate section 222, leading aggregate section 224, mixer conveyor 226, and mixing equipment section 228. Preferred trailing aggregate section 222 comprises four aggregate bins 230 adapted to receive, hold, and discharge aggregate materials. Preferably, each of the four aggregate bins 230 is adapted to receive, hold and discharge a different sized aggregate material. Preferred trailing aggregate section 222 also comprises trailing aggregate conveyor 232 which is adapted to convey aggregate material discharged by aggregate bins 230 toward leading aggregate section 224. Preferably, trailing aggregate conveyor 232 conveys the different aggregate materials discharged by aggregate bins 230 in multiple layers wherein each layer is a different-sized aggregate material and each layer includes the exact proportional amount of the respective different-sized aggregate material.

Still referring to FIG. 8, preferred leading aggregate section 224 comprises three aggregate bins 240. Preferred aggregate bins 240 are adapted to receive, hold and discharge aggregate materials. Preferably, each of the three aggregate bins 240 is adapted to receive, hold and discharge a different sized aggregate material. Preferred leading aggregate section 224 also comprises leading aggregate conveyor 242 which is adapted to convey aggregate material discharged by aggregate bins 240 toward mixer conveyor 226. In addition, preferred leading aggregate conveyor 242 comprises moisture sensor 244 which is adapted to determine the level of moisture in the aggregate materials. More particularly, preferred moisture sensor 244 is adapted to measure the hydrogen content of aggregate material. Preferred moisture sensor 244 comprises a gamma-emitting radioisotope source and a neutron-emitting radioisotope source mounted below the conveyor. Preferred mixer conveyor 226 is adapted to receive aggregate materials from leading aggregate conveyor 242 and convey them to mixing equipment section 228. In addition, preferred mixer conveyor 226 comprises belt sampler 246 which is adapted to provide an accurate, real-time aggregate material sampling to ensure the aggregate material mixture is on spec.

Still referring to FIG. 8, preferred mixing equipment section 228 comprises mixer 250 and concrete mix conveyor 252. Preferred mixer 250 is adapted to receive aggregate materials from mixer conveyor 226. Preferred mixer 250 is also adapted to receive cement directly from cement silos 260 and 262 via closed connection, fly ash directly from fly ash silo 264 via closed connection, and water from water source 266 via closed connection. Cement is preferably conveyed to mixer 250 via a vane feeder variable frequency drive and an auger. It is also contemplated within the scope of the invention that the cement will require aeration in order to maximize control of the flow rate to the mixer. Preferably, mixer 250 is also adapted to mix the aggregate materials, cement, fly ash, and water to produce a concrete mix and discharge the concrete mix onto concrete mix conveyor 252. Preferred concrete mix conveyor 252 is adapted to convey concrete mix to a surge hopper, but it is contemplated within the scope of the invention that the concrete mix conveyor may convey concrete mix to any suitable device, mechanism, assembly, or combination thereof adapted to store and/or transport concrete mix. Preferred concrete plant 220 also comprises control system 268 which is adapted to continuously and in real time control the amounts of the concrete components added to the mix. More particularly, preferred control system 268 is adapted to control the flow rate of the aggregate materials, the binder materials, the add mixtures, and the liquids added to the mixer to produce the finished concrete mix. Preferred control system 268 is also adapted to control the rotational speed of the mixer.

While FIG. 8 illustrates the preferred arrangement and configuration of concrete plant 220, it is contemplated within the scope of the invention that the concrete plant may be of any suitable arrangement and configuration.

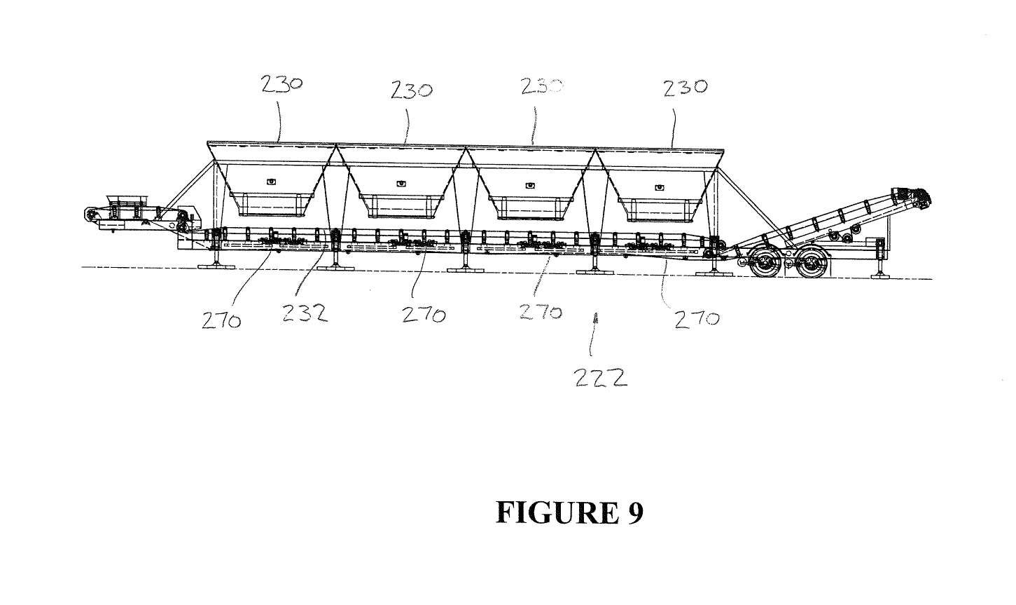

Referring now to FIG. 9, a front view of trailing aggregate section 222 of preferred concrete plant 220 is illustrated. As shown in FIG. 9, preferred trailing aggregate section 222 comprises four aggregate bins 230. Preferred aggregate bins 230 are calibrated for exact proportioning using variable frequency drive belts and live, calibrated bin gates. Further, preferred aggregate bins 230 are adapted to control the amount of aggregate material discharged by each of the aggregate bins continuously and in real time. Preferably, each aggregate bin 230 is adapted to discharge aggregate materials onto an individual feeder belt which then discharges onto trailing aggregate conveyor 232. Preferred trailing aggregate conveyor 232 is covered to prevent weather elements from affecting the mix. In addition, preferred trailing aggregate section 222 comprises scales 270 which are disposed beneath each of the feeder belts and adapted to continuously and in real time determine the weight of the aggregate materials discharged from each of the aggregate bins 230. Preferred scales 270 are dual-idler weigh bridges, but it is contemplated within the scope of the invention that any suitable device, mechanism, assembly, or combination thereof may be used to determine the amount of aggregate material discharged by aggregate bins 230. While FIGS. 8 and 9 illustrate a trailing aggregate section having four aggregate bins, it is contemplated within the scope of the invention that the trailing aggregate section may have more or fewer than four aggregate bins. It is also contemplated within the scope of the invention that each of the aggregate bins 230 may also comprise a vibrator and/or a dancing plate to prevent aggregate material from sticking to the bin walls. It is further contemplated within the scope of the invention that each of the aggregate bins 230 may also comprise a moisture sensor adapted to determine the level of moisture in the aggregate materials.

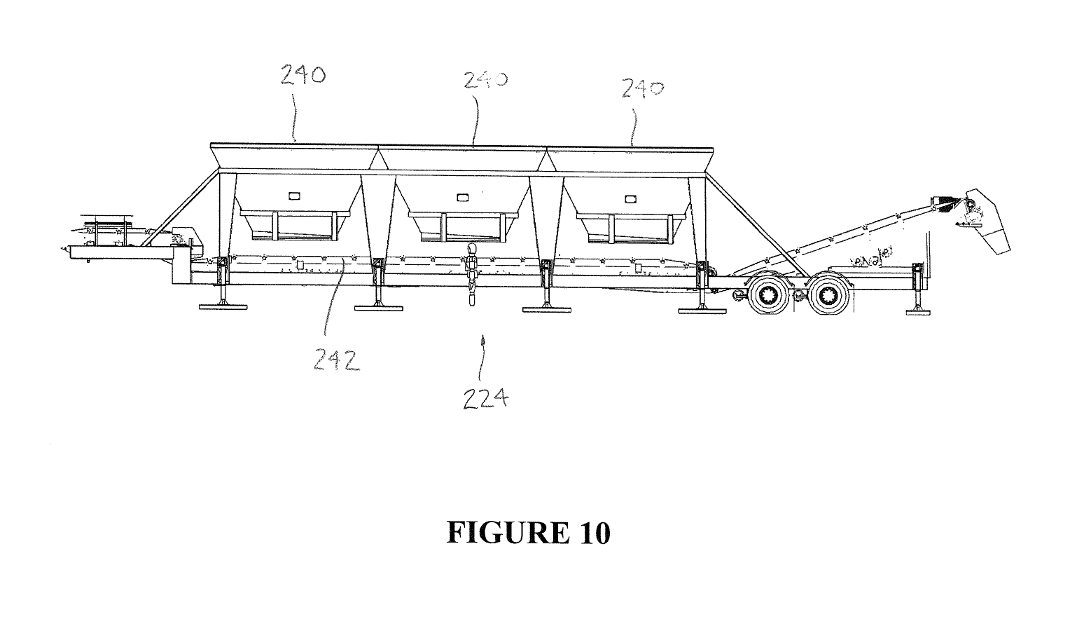

Referring now to FIG. 10, a front view of leading aggregate section 224 of preferred concrete plant 220 is illustrated. As shown in FIG. 10, preferred leading aggregate section 224 comprises three aggregate bins 240. Preferably, aggregate bins 240 are adapted to discharge aggregate materials onto leading aggregate conveyor 242. In addition, preferred leading aggregate section 224 comprises a plurality of scales which are disposed beneath each of the feeder belts and adapted to continuously and in real time determine the weight of the aggregate materials discharged from each of the aggregate bins 240. Further, preferred aggregate bins 240 are calibrated for exact proportioning using variable frequency drive belts and live, calibrated bin gates which are adapted to control the amount of aggregate material discharged by each of the aggregate bins 240 continuously and in real time. Still further, preferred leading aggregate conveyor 242 comprises a moisture sensor 244 which is adapted to continuously and in real time determine the level of moisture in the aggregate materials. While FIGS. 8 and 10 illustrate a leading aggregate section having three aggregate bins, it is contemplated within the scope of the invention that the leading aggregate section may have more or fewer than three aggregate bins. It is also contemplated within the scope of the invention that each of the aggregate bins 240 may also comprise a vibrator and/or a dancing plate to prevent aggregate material from sticking to the bin walls. It is further contemplated within the scope of the invention that each of the aggregate bins 240 may also comprise a moisture sensor adapted to determine the level of moisture in the aggregate materials.

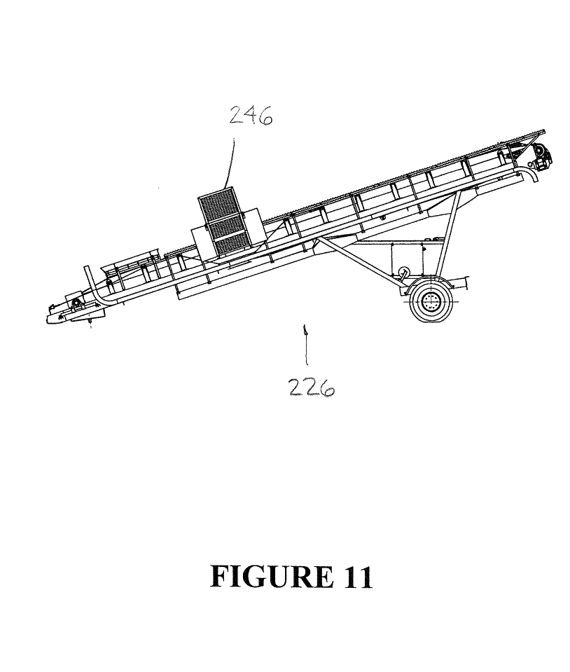

Referring now to FIG. 11, a front view of mixer conveyor 226 of preferred concrete plant 220 is illustrated. Preferred mixer conveyor 226 is adapted to receive aggregate materials from the leading aggregate conveyor and convey them to mixing equipment section 228. In addition, preferred mixer conveyor 226 comprises belt sampler 246 which is adapted to provide an accurate, real-time aggregate material sampling to ensure the aggregate material mixture is within the specifications for the finished concrete mix. While FIG. 11 illustrates the preferred configuration and arrangement of the mixer conveyor, it is contemplated within the scope of the invention that the mixer conveyor may be of any suitable configuration and arrangement.

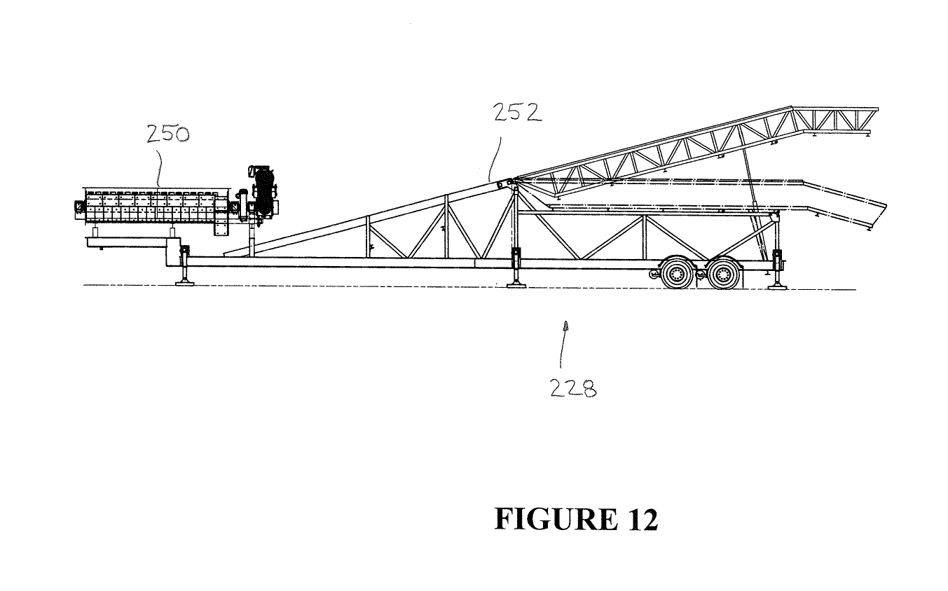

Referring now to FIG. 12, a front view of mixing equipment section 228 of preferred concrete plant 220 is illustrated. Preferred mixing equipment section 228 comprises mixer 250 and concrete mix conveyor 252. Preferred mixer 250 is a twin-shaft continuous serpentine mixer, but it is contemplated within the scope of the invention that the mixer may be any suitable device, mechanism, assembly, or combination thereof adapted to mix the different components of concrete. Preferably, the components of the concrete mix enter mixer 250 though a water curtain produced by nozzles encircling the dry component inlet to ensure that metered water showers every lineal foot of pre-blended aggregates and cements using the water conveyed from water source 266. Preferred mixer 250 comprises a plurality of paddles disposed at a number of different angles which are adapted to uniformly and completely mix the concrete components. In addition, preferred mixer 250 includes a wash-down system having a plurality of nozzles inside the mixing chamber which are adapted to thoroughly wash down the interior and flush all of the concrete mix through the discharge gate and out of the mixer. The wash-down system may be activated either manually or automatically. It is also contemplated within the scope of the invention that preferred mixer 250 also comprises a liquid nitrogen valve adapted to permit liquid nitrogen to be conveyed into the mixer in order to reduce the temperature in the mixing chamber. In preferred concrete plant 220, the amount of water conveyed to mixer 250 is controlled continuously and in real time by Coriolis mass-flow meters and the amount of cement conveyed to the mixer is controlled continuously and in real time by a mass weight system in order to constantly maintain the correct water-cement ratio. More particularly, the amount of water and cement conveyed to mixer 250 is determined by the flow rate of the aggregate materials (mass or volume) and the free flow moisture level of the aggregate materials.

While FIG. 12 illustrates the preferred configuration and arrangement of the mixing equipment section, it is contemplated within the scope of the invention that the mixing equipment section may be of any suitable configuration and arrangement.

In operation, the preferred concrete plant is adapted to control the amount of each ingredient of the concrete mix continuously and in real time. More particularly, the preferred concrete plant is adapted to determine the amount of each ingredient being added to the concrete mix continuously and in real time. Preferably, the amount of each ingredient being added to the concrete mix is measured on a belt scale (i.e. mass flow rate), but it is contemplated that the amount of each ingredient may be determined by volume or any other suitable measure. The continuous and real-time collection of this data is input into the control system which is adapted to control the amount of each ingredient being added to the concrete mix continuously and in real time based on the collected data. The preferred control system is adapted to continuously and in real time adjust the amount of each concrete ingredient added to the concrete mix based on the continuously collected data relating to the amounts of other concrete ingredients being added to the concrete mix.

In the preferred concrete plant, the weight of the aggregate material is continuously measured and that data is continuously input into the control system. Based on the aggregate weight data, other concrete ingredients (e.g., cement, sand, rock, fly ash and other add-mixes) are added to the mix in an amount that is proportional to the weight of the aggregate. Thereafter, add-water is introduced to the mixture so that the total water is in proper proportion to the cement. The dynamic, continuous, real-time proportioning of concrete ingredients achieved by the preferred concrete plant produces a concrete mix having more accurate and precise proportions of each ingredient. Consequently, the quality of concrete produced by the preferred concrete plant is far superior to concrete produced by conventional batch plants. Further, the dynamic, continuous, real-time proportioning of concrete ingredients achieved by the preferred concrete plant may be applied to a conventional batch production process or a continuous flow production process.

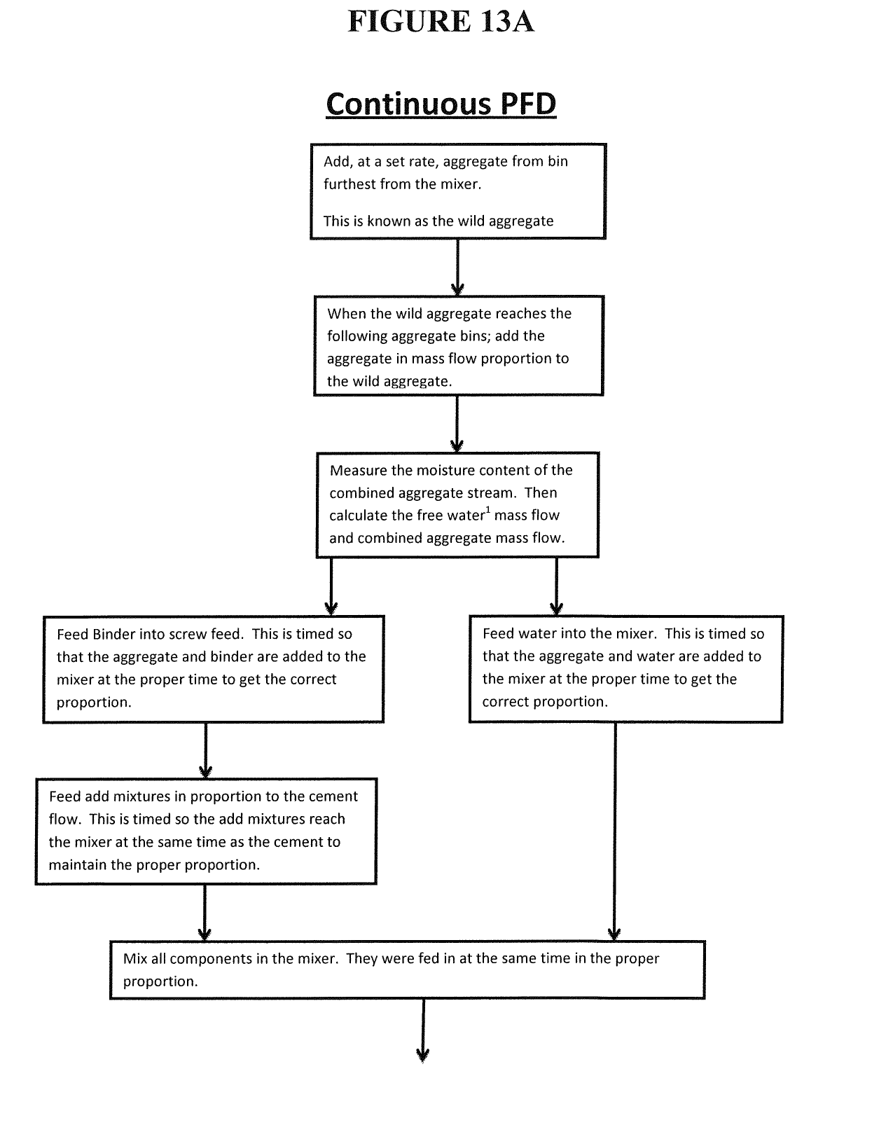

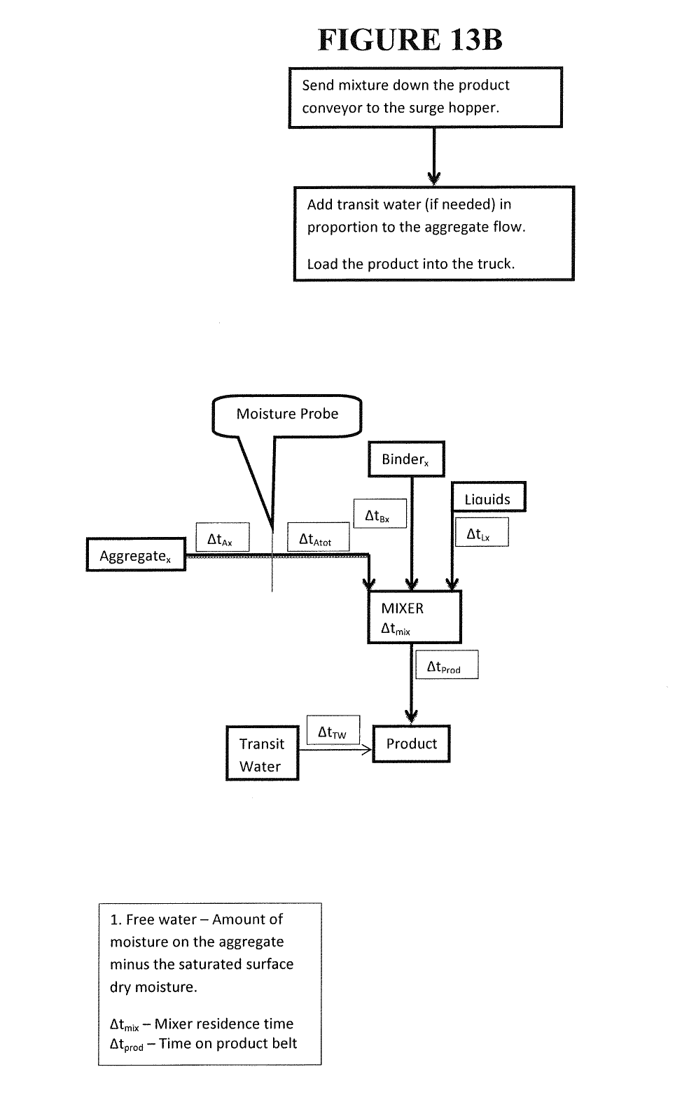

FIGS. 13A and 13B are a flow chart illustrating the preferred method for continuously controlling component amounts in a concrete mixture in accordance with the present invention. As shown in FIGS. 13A and 13B, the preferred method comprises a number of steps. More particularly, the preferred method comprises initially providing aggregate material from the bin farthest from the mixer at a pre-determined set rate. The aggregate material from the bin farthest from the mixer is referred to as the wild aggregate. The wild aggregate from the bin farthest from the mixer is then conveyed toward the other aggregate bins and the mixer. When the wild aggregate reaches the other aggregate bins, aggregate material from the other bins is added to the wild aggregate in mass flow proportion to the wild aggregate. If the mass flow rate of the wild aggregate changes over time, the mass flow proportion of aggregate added from the other bins also changes in order to continuously maintain the proper proportions of different aggregate materials in the combined aggregate stream.

Still referring to FIGS. 13A and 13B, in the preferred method, after the combined aggregate stream is conveyed past the aggregate bin closest to the mixer, the moisture of the combined aggregate stream is measured and the free water mass flow and the combined aggregate mass flow are calculated. The free water mass flow is the amount of moisture on the combined aggregate stream minus the saturated surface dry moisture. The free water mass flow and combined aggregate mass flow calculations are used to calculate the amounts of binder material, add mixtures, and liquid added to the mixer downstream. More particularly, as the free water mass flow and/or combined aggregate mass flow calculations change, the amounts of binder material, add mixtures and liquid added to the mixer downstream may also change in order to maintain the proper proportions of each in the finished concrete mix.

Still referring to FIGS. 13A and 13B, in the preferred method, binder material such as cement is fed into a screw feed such that the combined aggregate stream and the binder material are added to the mixer at the proper time in order to achieve the correct proportions of each. Add mixtures such as fly ash are also fed into the mixer at the proper time in order to achieve the correct proportions of binder material and add mixtures. In addition, liquids such as water are fed into the mixer such that the combined aggregate stream and the liquids are added to the mixer at the proper time in order to achieve the correct proportions of each.

Still referring to FIGS. 13A and 13B, in the preferred method, the combined aggregate stream, binder material, add mixtures, and liquids are mixed in the mixer. As described above, all of the components of the concrete mix are added to the mixer at the same time and in the proper proportions. After the mixer mixes the components of the concrete mix, the concrete mix is conveyed to a surge hopper. If needed, transit water may be added to the concrete mix in proportion to the aggregate flow. The concrete mix may then be loaded into a transport vehicle.

While FIGS. 13A and 13B illustrate the preferred method for continuously controlling component amounts in a concrete mixture in accordance with the present invention, it is contemplated within the scope of the invention that the method may comprises fewer or more steps and that the sequence of the steps may be varied.

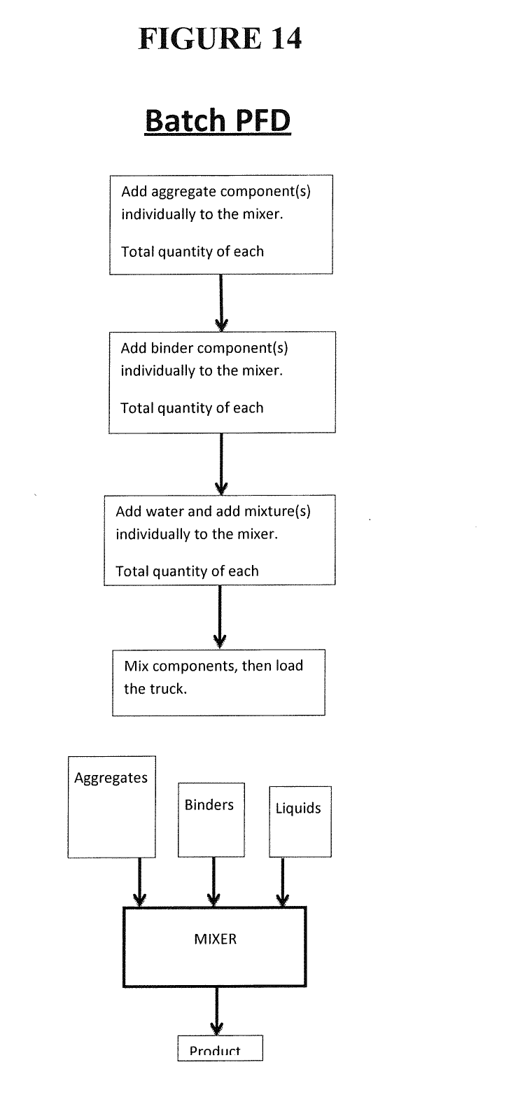

FIG. 14 is a flow chart illustrating the conventional batch method for producing concrete. As shown in FIG. 14, in a conventional batch method for producing concrete, the amounts of the components of a concrete mix are not varied continuously or in real time during the production process. Instead, in a conventional batch method for producing concrete, static and fixed amounts of each component of a concrete mix are pre-determined and set prior to the start of production. More particularly, a total amount of each type of aggregate material, each binder component, each liquid component, and each add mixture is pre-determined for a discrete batch of concrete mix. If the mass flow rate of one of more of the components of the concrete mix varies, the proportions of the components in the finished concrete mix will also undesirably change because of the static nature of the conventional batch method for producing concrete. Because the mass flow rate of each component of a concrete mix is not determined continuously and in real time in a conventional method for producing concrete, a change in mass flow rate of one or more components of the concrete mix cannot be determined. Further, in a conventional method for producing concrete, the mass flow rates of one or more components of a concrete mix are not automatically varied in response to a change in mass flow rate of one or more other components of the concrete mix in order to maintain the proper proportions of each component of concrete in the final concrete mix.

As noted above, the invention also comprises a method for producing concrete. According to the preferred embodiments of the method for producing concrete, a concrete plant such as the concrete plants described and illustrated herein is provided. The preferred methods for producing concrete also comprise providing fine aggregate, cement, intermediate aggregate, flyash, coarse aggregate, additives and water. Water may be added to the concrete components at the concrete plant or at a remote location such as in a mixer truck. Preferably, the fine aggregate, cement, intermediate aggregate, flyash and coarse aggregate are at least partially mixed before they are introduced into the mixer. The preferred methods for producing concrete further comprise mixing the aggregate (coarse, intermediate and/or fine), cement, flyash, additives and water to produce concrete. While aggregate (coarse, intermediate and/or fine), cement, flyash, additives and water are the preferred components of the concrete produced by the preferred methods of the invention, it is contemplated that more, fewer or different components may be used to produce concrete in accordance with the present invention. It is also contemplated within the scope of the invention that the plurality of concrete components may be provided in any suitable sequence and in any suitable proportions to produce concrete in accordance with the present invention.

In the preferred methods for producing concrete, the size and amount of aggregates used to produce concrete are precisely and accurately controlled. More particularly, according to preferred methods for producing concrete, the size of the aggregate used to produce concrete is precisely and accurately controlled by rock crushers, screens and/or vibrating decks. It is contemplated that the crushing and screening may occur at a quarry or at the concrete plant by a dedicated screening system. In the case of a batch concrete plant, a multi-deck screen located on the top of a batch tower may be used to segregate aggregate into separate, substantially uniform sizes and deposit each of the substantially uniformly-sized aggregates into different bins within the batch tower. A batch concrete plant, like a continuous flow concrete plant, may also include a plurality of aggregate feed bins. It is also contemplated within the scope of the invention that the aggregate may be segregated into separate, substantially uniform sizes by any suitable means for segregating aggregate into separate, substantially uniform sizes.

In the preferred embodiments of the method for producing concrete, the amount or percentage of each substantially uniformly-sized aggregate (e.g., coarse, intermediate and fine) may be precisely and accurately controlled by volume or weight. In some preferred embodiments, the amount or percentage of each substantially uniformly-sized aggregate is precisely and accurately controlled by a volume using a variable speed volumetric belt feeder or any other suitable device, mechanism, assembly or combination thereof. In other preferred embodiments, the amount or percentage of each substantially uniformly-sized aggregate is precisely and accurately controlled by weight using a load cell, a belt scale, a weigh idler or any other suitable device, mechanism, assembly or combination thereof. It is contemplated within the scope of the invention that the amount or percentage of each substantially uniformly-sized aggregate may be achieved by any suitable means for precisely and accurately controlling the amount or percentage of aggregate provided.

In operation, the preferred embodiments of the apparatus and method of the invention achieve several advantages. For example, the preferred embodiments of the invention provide a method and an apparatus for a modular and portable concrete plant that precisely and accurately controls the mixture of concrete components, including the stone and sand components of concrete. The preferred embodiments of the invention provide an apparatus and a method for screening the stone components of concrete to a desired size before introducing the stone components into the concrete mixture. The preferred embodiments of the invention also provide an apparatus and a method for knowing with a high degree of certainty the sizes and quantities of the stone components that are used in the concrete mixture. The preferred embodiments of the invention further provide an apparatus and a method for preventing similar sized stones from segregating away from different sized stones and to increase the uniformity of the stone components throughout the concrete.

In addition, the preferred embodiments of the invention provide an apparatus and method for using less cement as a component of concrete. The preferred embodiments of the invention also provide an apparatus and method for continuously producing concrete, as well as producing batches of concrete, in order to increase production capacity. The preferred embodiments of the invention further provide an apparatus and method for at least partially mixing the components of concrete before they are introduced into the mixer. The preferred embodiments of the invention still further provide an apparatus and method for producing concrete that experiences reduced failure rates and longer lifespans. Finally, the preferred embodiments of the invention provide an apparatus and method for a portable concrete plant that may be set up and operational in a reduced amount of time.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A method for continuously controlling component amounts in a concrete mixture, said method comprising:
(a) providing a concrete plant adapted to continuously produce and continuously control a concrete mixture, said concrete plant comprising:
(1) one or more aggregate feed bins, said one or more aggregate feed bins being adapted to hold and release aggregate materials;
(2) one or more feed conveyors, said one or more feed conveyors being adapted to receive an amount of the aggregate materials from the one or more aggregate feed bins;
(3) a collecting belt conveyor, said collecting conveyor being adapted to receive an amount of the aggregate materials from the one or more feed conveyors;
(4) one or more silo assemblies, said silo assemblies being adapted to hold and release components of concrete;
(5) one or more screw conveyors, said one or more screw conveyors being adapted to receive an amount of the components of concrete from the one or more silo assemblies and convey the components of concrete to the collecting belt conveyor;
(6) a mixer, said mixer being adapted to receive the aggregate materials and components of concrete from the collecting belt conveyor and mix the aggregate materials and components of concrete with water;
(7) a microprocessor, said microprocessor being adapted to control the operation of the one or more feed conveyors and monitor one or more load cells;
wherein the amount of aggregate materials received by the collecting belt conveyor from the one or more feed conveyors and the amount of concrete components received by the collecting belt conveyor from the one or more screw conveyors are continuously controlled;
(b) mixing the aggregate materials and the components of concrete with water in the mixer to produce concrete.

2. The method for continuously controlling component amounts in a concrete mixture of claim 1 wherein the one or more aggregate feed bins include a fine aggregate feed bin, an intermediate aggregate feed bin, and a coarse aggregate feed bin.

3. The method for continuously controlling component amounts in a concrete mixture of claim 1 wherein the one or more feed conveyors are adapted to operate at variable speeds.

4. The method for continuously controlling component amounts in a concrete mixture of claim 1 wherein the collecting belt conveyor includes a substantially horizontal portion and an inclined portion.

5. The method for continuously controlling component amounts in a concrete mixture of claim 1 wherein the one or more silo assemblies includes a weigh pot.

6. The method for continuously controlling component amounts in a concrete mixture of claim 1 further comprising a mixer conveyor, said mixer conveyor being adapted to receive the aggregate materials and components of concrete from the collecting belt conveyor and convey the aggregate materials and components of concrete to the mixer.

7. The method for continuously controlling component amounts in a concrete mixture of claim 1 wherein a wash-down system adapted to wash the interior of the mixer is provided.

8. The method for continuously controlling component amounts in a concrete mixture of claim 1 wherein a water tank is provided.

9. The method for continuously controlling component amounts in a concrete mixture of claim 1 wherein the amount of the aggregate materials, the amount of the components of concrete, the speed of the one or more feed conveyors, and the speed of the collecting belt conveyor are automatically and continuously controlled by the microprocessor.

10. The method for continuously controlling component amounts in a concrete mixture of claim 1 wherein the aggregate materials and the components of concrete are deposited on the collecting belt conveyor in layers.

11. The method for continuously controlling component amounts in a concrete mixture of claim 1 wherein concrete is produced in a continuous flow.

12. The method for continuously controlling component amounts in a concrete mixture of claim 1 wherein the aggregate materials are weighed to determine an aggregate materials weight.

13. The method for continuously controlling component amounts in a concrete mixture of claim 12 wherein the aggregate materials are weighed by the one or more load cells.

14. The method for continuously controlling component amounts in a concrete mixture of claim 12 wherein the aggregate materials weight is used to determine the amount of components of concrete.

15. The method for continuously controlling component amounts in a concrete mixture of claim 12 wherein the aggregate materials weight is dynamically used to determine the amount of components of concrete.

16. The method for continuously controlling component amounts in a concrete mixture of claim 1 wherein substantially uniformly sized aggregate are used.

17. The method for continuously controlling component amounts in a concrete mixture of claim 1 wherein the one or more load cells are operatively connected to the microprocessor.

18. The method for continuously controlling component amounts in a concrete mixture of claim 1 wherein the one or more load cells are adapted to determine a silo weight.

19. The method for continuously controlling component amounts in a concrete mixture of claim 7 wherein the wash-down system is activated by the microprocessor.
